(19) United States
(12) Patent Application Publication
(10) Pub. No.: US 2011/0304429 A1
(43) Pub. Date: Dec. 15, 2011

(54) METHOD AND APPARATUS FOR IMPROVING BIOMETRIC IDENTIFICATION SYSTEMS

(76) Inventor: Thomas Wolfl, Regensburg (DE)

(21) Appl. No.: 13/002,893

(22) PCT Filed: Jun. 30, 2009
(86) PCT No.: PCT/EP09/58210

§ 371 Date: Aug. 29, 2011

(30) Foreign Application Priority Data
Jul. 8, 2008 (DE) 10200840258.3

(51) Int. Cl. G06F 7/04

(52) U.S. Cl. 340/5.83; 340/5.82

(57) ABSTRACT

The present invention relates to a method and an apparatus for identifying a person, in which biometric data are acquired for the person to be identified, wherein the person to be identified must carry out a recognition action, on the basis of which the biometric data used for identification are determined, wherein at least one step from a group of checking steps is carried out, said step comprising the random selection of the recognition action and the additional solution to a problem, and wherein the problem is a problem which is suited to human capabilities and cannot be solved by automated systems or can only be solved by automated systems with a time requirement which exceeds a particular time requirement needed by an average person.

### FIELD OF THE INVENTION

The present invention relates to a method and apparatus for identifying a person in which biometric data of the person to be identified are acquired, wherein the person to be identified must carry out a recognition action, on the basis of which the biometric data used for identification are determined.

### BACKGROUND OF THE INVENTION

Biometric methods are increasingly being used to identify individuals, such as for access control to secure areas or when logging into a data processing system, such as a personal computer. The reason is that the widely used method of passwords, as a means of identification and access control, has diverse security gaps, and is inconvenient for users because they ought to change the password very frequently for security reasons, but might experience problems remembering them. This means that users either rely on unchanging, insecure passwords or experience difficulties during access identification.

Biometric identification systems have the advantage here of being much more secure, since access to the biometric data, i.e., the scope for copying them, is much more difficult than is the case for a password which, if not kept properly secret, is easy to use. For another thing, biometric identification systems are more convenient for users, who automatically and effortlessly carry the biometric properties around with them and so do not have to remember passwords.

However, even biometric identification systems have some security gaps since it is conceivable, for example, that spyware and the like could acquire a biometric access data record and use it as part of a replay attack.

### SUMMARY OF THE INVENTION

It is possible to effectively prevent a data record or signal record which has already been used once from being used for unauthorized access or to fraudulently authenticate a person (replay attack) by basing the biometric method on at least two, recognition actions, so that one of the two or several recognition actions can be chosen, particularly selected at random, for the corresponding access control. Such a recognition action for a biometric method, for example, can include capturing data from a human body part, such as a fingerprint or an eye. Since humans usually have two eyes, recognition via the eye affords the possibility of using either the left or the right eye. For fingerprint recognition, the ten different fingers may be used. Since human body parts are usually not 100% identical, it is also possible to recognize the actual body part being used. If the identification system is now designed such that the system prescribes the recognition action and selects it from a plurality, i.e., at least two, of recognition actions, there is a certain probability that any attempt to use saved data to circumvent identification will lead to the use of a false recognition action, which was previously captured without authorization, such that the attempt at deception can be discovered. In this way it can be assumed with greater certainty that it is a real living person (live recognition) which is in fact undergoing biometric identification and not a saved data record that is being transmitted to deceive a machine. Such a security function could be overcome only if, for the attempted deception, all possible recognition actions were available as a data record.

A corresponding security feature lends itself very readily, for example, to the biometric method of keystroke recognition which analyzes the typing pattern of the person to be identified from the actuation of a keyboard or a keypad and the like. In this case, an aspect of the present system for identifying an individual can specify a specific text for typing on a keyboard or a specific key sequence, such that the system, through a simple comparison, if the correct keys or right key sequence have been pressed can recognize, whether current recognition actions have been made for the current access attempt, or whether attempts have been made with previously recorded recognition actions to achieve unauthorized access or to feign a false identity.

Additionally or alternatively, a corresponding biometric identification system can also be improved by the corresponding identification system's setting an additional task for the person to be identified to solve, wherein the task is tailored to human capabilities, i.e., the task can be solved much faster by an individual than by a machine or a data processing device or it can actually be solved by a person only.

Examples of such additional tasks can comprise the recognition of structures in an image and the reproduction of the recognized structure and/or answering a question about the structure to be recognized.

For example, in a display device such as a monitor, the system can display an image comprising a sequence of numbers and/or letters, wherein the numbers and/or letters can be arranged in any orientation. In such an arrangement, an automatic system for recognizing the structure has difficulty recognizing the corresponding numbers and letters, whereas a person can easily recognize the sequence of numbers and/or letters.

The same applies to the visualization of an object, and so the naming of that object can be required by way of additional task. The determination that a person is solving the additional task and thus the proof that it is actually a person undergoing identification and not a machine with saved data becomes all the more pronounced if the image comprises the structure against a background which hampers recognition of the structure, i.e., is more difficult for an automated recognition system to recognize. For example, this is the case when the background against which the structure is shown has a plurality of similarly shaped surfaces and/or lines with, e.g., colors and the like, which are similar to those of the structure. Such a case poses extreme difficulties for a corresponding automated recognition system, which will need a vast length of time to solve this task, if at all.

Accordingly, by way of additional variant, a requirement could be that solving of the additional task must commence or be completed within a specific time requirement, with the time requirement being based on an average person. If this time requirement is exceeded, the system recognizes this fact and cancels the identification with a negative result, since it cannot be a human user attempting identification, but rather it is possibly an attempt at unauthorized identification on the basis of automated recognition.

Particularly in the case of biometric recognition by means of typing patterns, the additional security features can be integrated into the actual recognition through input of a keystroke. Thus, a choice of a particular text to be entered can be linked to the display of an image, in which the text is readily recognizable by a human only, with the result that this additional task of recognizing a structure is already integrated. At the same time, the time component, i.e., verification that starting typing of the character string by the user or completion of typing of the character string by the user has occurred within a prescribed time period, can also be integrated, such that all additional security features of the present invention, namely prescribing a specific recognition action out of several recognition actions (input of a specific text or a typing sequence), solving an additional task (reading a text or typing sequence from a non-machine-readable image) and time control, can easily be realized in the biometric method of keystroke recognition.

### BRIEF DESCRIPTION OF THE FIGURES

Further advantages, characteristics and features of the present invention are apparent from the following detailed description of embodiments with reference to the accompanying drawings, with the drawings showing in purely schematic form:

FIG. 1 a view of a data processing system with which the invention can be carried out, and which is configured to a corresponding inventive apparatus;

FIG. 2 an illustration of a structure in an image, which can find use in the present invention, and in FIG. 3 an illustration of a further structure in an image for use with the present invention.

### DETAILED DESCRIPTION OF AN EMBODIMENT OF THE INVENTION

The present invention can be used in many biometric identification systems, in which biometric data for identifying an individual on the basis of several recognition actions are captured. Correspondingly, biometric methods can be used which are based on recognition of a body part, such as the eyes or fingerprints, or in which biometric data can be captured by means of input into an apparatus by the person to be identified. This can, for example, be voice recognition, in which the user must say a particular or an arbitrary sentence, such that frequencies, frequency sequences and the like can be determined from the acquired sounds and phonemes so that the identity of a user can be established. Another option is to capture the typing pattern of the user during actuation of a keyboard. This can be accomplished, for example, by the user's inputting an arbitrary or specific text or an access code and the like into a keyboard. The term keyboard here is to be understood in a very broad sense, such that it may be a standard keyboard of a personal computer or an abridged number pad for an access control or a pushbutton for entering a key sequence in the nature of Morse code. The keys of a corresponding keyboard may likewise be configured in many different ways. They can be conventional, depressible keys of a computer keyboard, or key fields on a surface that respond to pressure, such as a monitor and the like.

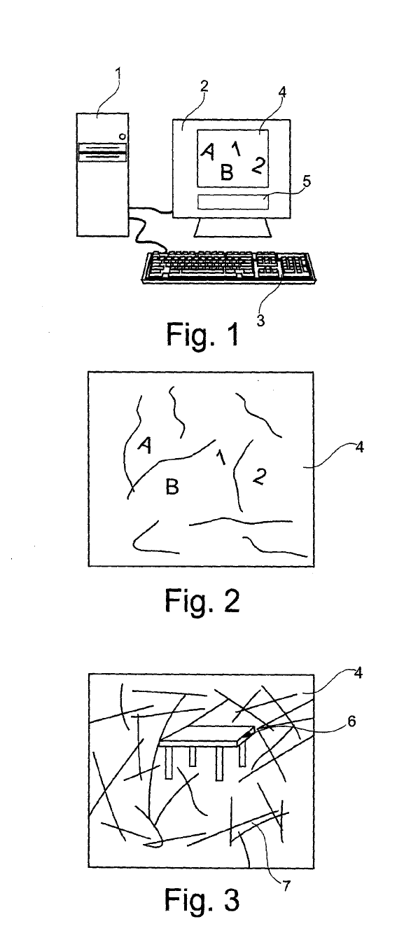

FIG. 1 shows a standard personal computer PC 1 with a monitor 2 as an output device and a conventional keyboard 3 as an input device. Such a PC system can be configured as an identification apparatus in accordance with the present invention, so that a method of identifying a person in accordance with the present invention can occur on it.

The following described embodiments are based on keystroke recognition as a biometric method, as already described in various documents. For example, reference is made to publication WO 98/06020 A2, in which the present invention can be used. However, the present invention is not limited to biometric data capture by means of keystroke recognition, or to the embodiment of keystroke recognition identification that is described in the above-cited PCT application.

Identification of a user of the PC 1 can be carried out in such a way that the user is prompted to input a specific or arbitrary text on the keyboard 3 when the system is started.

Stored in memory units of the personal computer, not specified in further detail, is a data processing program for user identification which runs accordingly and steers the identification process. In particular, the data processing program forms a capture device that captures values which are determined by sensors or electrical signals and which are triggered by actuation of the keyboard 3, and evaluates them in such a way that information about the typing pattern is generated, which a corresponding evaluation unit, which is also realized in large part by the data processing program, compares with the saved biometric data of a person to be identified, such that the identity of the user can be ascertained where there is a corresponding match.

The PC 1, equipped with corresponding software, further realizes a module for determining the authenticity of the biometric data in accordance with the present invention in order to rule out the possibility that fake biometric data are being used which have been captured and saved, for example, by spyware and the like, during a previous identification, and are now intended to be used automatedly in their saved form for gaining access to the PC system.

The module for determining the authenticity of the biometric data uses a random generator to randomly select a specific text from a plurality of different possibilities, for the purpose of determining the typing pattern. Unlike systems of the prior art, the user can therefore no longer always input the same text or even freely choose which text to enter, but rather must at least in part use the text prescribed by the random generator, said text being used for the determination of the typing pattern characteristics. In this way, the possibility is ruled out that a data record saved at any time can serve as supposed keyboard input during an identification or access control, since there is a very low probability that the saved data regarding key actuation will match the prescribed inputs by chance.

Additionally or alternatively, the module for determining the authenticity of the biometric data is provided with a task generator that generates an additional task for the person to be identified or for the user seeking access to the PC system 1, preferably for solving within a timeframe usual for a human. This task is designed such that a machine or an automated system cannot solve it at all or would require substantially more time to do so.

For these tasks, so-called CAPTCHA (Completely Automated Public Turing Test to Keep Computers and Humans Apart) can be used. Such tests comprise, for example, the recognition of a sequence of letters and/or numbers, wherein the letters and/or numbers are arranged in an arbitrary orientation, especially against a background that makes automatic pattern recognition extremely difficult for a machine or a computer.

In the same way, structures such as simple objects can be presented in a manner that also makes it difficult for an automated recognition system to recognize the corresponding object. This can be accomplished, for example, by having the object consist of a plurality of identically colored or different-colored surface regions, wherein the background is also composed of similarly shaped or similarly colored surface regions, so that the object is very quickly recognizable to a skilled human eye, whereas an automated recognition system must engage in a tedious process of pattern matching, if pattern recognition is possible at all in the first place.

Examples of this are shown in FIGS. 2 and 3, with FIG. 2 showing an image with a letters-numbers sequence AB12 against a background of further lines and the like, with the letters and numbers being in different orientations. The letters-numbers sequence of image 4 can be displayed on the monitor 2, with the user having to use the keyboard 3 to input the corresponding letters or number sequence into an input box 5.

FIG. 3 shows a further variant of such a task tailored to human capabilities, in which a simple structure, such as the table 6, must be recognized against a background of a number of similar surfaces 7. Insofar as the image 4 of FIG. 3 is displayed on the monitor 2 during access control in the PC system of FIG. 1, an additional task may be to pose the question as to which object can be recognised in image 4, whereupon the user or the person to be identified must enter the term “table” in the box 5 via the keyboard.

In this way, in addition to the underlying recognition of the typing pattern first by means of a text chosen randomly and prescribed by the system, the possibility that a recorded actuation of the keyboard 3 is being used for access control is ruled out. Subsequently, the additional task, which requires recognition of, e.g., the letters-numbers sequence of FIG. 2 or the object of FIG. 3 in the image 4, can be used to further determine whether in fact there is a human sitting in front of the PC 1 and the keyboard 3. The additional task which the identification system sets for the user can be solved by a human only in a given time, if at all, with the time being based on the time requirement which an average user would need and which is far shorter than that which an automated system, such as an image recognition system, would need for solving for the set task.

The time component can be configured for one thing such that correct input, i.e., the solution of the additionally posed task, must occur within a certain timeframe. Additionally or alternatively, it can also be configured such that at least input, e.g., of the password, must have commenced.

Although the present invention has been described in detail using the attached embodiments, it is obvious to a person skilled in the art that the invention is not restricted to these embodiments, but rather the invention also comprises modifications and changes, which especially comprise the omission of individual features presented or other combinations of features presented, provided that no departure is made from the protective scope of the accompanying claims. In particular, the present invention comprises all combinations of all presented characteristics.

1-16. (canceled)

17. A method for identifying a person comprising:
acquiring biometric data for the person to be identified;
determining the biometric data by having the person carry out at least one recognition action;
carrying out at least one checking step comprising randomly selecting one of the at least one recognition action and solving to a task which is suited to human capabilities and cannot be solved by automated systems or can only be solved by automated systems with a time requirement which exceeds a particular time requirement needed by an average person.

18. The method in accordance with claim 17, wherein:
solving the task must be started or completed within a time span which is less than a certain time requirement.

19. The method in accordance with claim 17, wherein:
at least one recognition action is selected from the group comprising typing on a keyboard, voice reproduction and visual capture of a human body part.

20. The method in accordance with claim 19, wherein:
the biometric data comprise a typing pattern, voice or speech recognition, fingerprint recognition and/or eye recognition.

21. The method in accordance with claim 17, wherein:
the task comprises a recognition of at least one structure in an image and a reproduction of the at least one structure and/or answering a question about the at least one structure.

22. The method in accordance with claim 21, wherein:
the image comprises a sequence of numbers and/or letters; and
the numbers and/or letters can be arranged in any orientation.

23. The method in accordance with claim 21, wherein:
the image comprises at least a pictorial illustration of an object and the reproduction comprises naming the object.

24. The method in accordance with claim 21, wherein:
the image comprises the structure with a background that hampers recognition of the structure.

25. The method in accordance with claim 24, wherein:
the structure and the background comprise a plurality of similarly shaped surfaces and/or lines and/or similar colors.

26. The method in accordance with claim 17, wherein:
the recognition action and the solving of the task proceed as a single action.

27. The method in accordance with claim 17, wherein:
the task is chosen from a plurality of different tasks.

28. An apparatus for identifying a person comprising:
a capture device for capturing biometric data of a person to be identified; and
an evaluation unit for comparing the captured biometric data with saved data of the person to be identified and determination of an identity of the person to be identified; and
a module for determining the authenticity of the biometric data comprising a random generator which randomly determines which biometric data are captured and/or has a task generator which generates a task which is suited to human capabilities and which cannot be solved by automated systems or can only be solved by automated systems with a time requirement which exceeds a particular time requirement.

29. The apparatus in accordance with claim 28, wherein:
the module for determining the authenticity of the biometric data comprises a memory for saving additional tasks and assigned solutions.

30. The apparatus in accordance with claim 28, wherein:
the module for determining the authenticity of the biometric data comprises an input unit for inputting a solution and a comparison unit for determining the correctness of the solution.

31. The apparatus in accordance with claim 28, wherein:
the module for determining the authenticity of the biometric data comprises a time-capture unit for determining a time between task presentation and start and/or completion of solution input.

32. An apparatus for identifying a person comprising:
a capture device for capturing biometric data of a person to be identified; and
an evaluation unit for comparing the captured biometric data with saved data of the person to be identified and determination of an identity of the person to be identified; and
a module for determining the authenticity of the biometric data comprising a random generator which randomly determines which biometric data are captured and/or has a task generator which generates a task which is suited to human capabilities and which cannot be solved by automated systems or can only be solved by automated systems with a time requirement which exceeds a particular time requirement;
wherein the apparatus is set up such that the method in accordance with claim 1 is realized by a sequence of a data processing program.
